(19) United States
(12) Patent Application Publication
(10) Pub. No.: US 2006/0122094 A1
(43) Pub. Date: Jun. 8, 2006

(54) Fabric enhancing composition

(76) Inventors: Ronald Musico Fabicon, Chaoyang (CN); Randall Alan Watson, Loveland, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/295,263

(22) Filed: Dec. 6, 2005

Related U.S. Application Data
(60) Provisional application No. 60/633,661, filed on Dec. 6, 2004.
(60) Provisional application No. 60/727,682, filed on Oct. 18, 2005.

(51) Int. Cl. C11D 3/00

(52) U.S. Cl. 510/521

(57) ABSTRACT

A rinse-added fabric enhancer composition has from about 0.01% to about 10% of a cationic polysaccharide polymer, from about 0.1 to about 50% of an anionic surfactant, and the balance adjunct ingredients. The cationic polysaccharide polymer has a weight average molecular weight of from about 400 g/mol to about 2,000,000 g/mol and a calculated charge density of from about 1% to about 50%, while the anionic surfactant has an alkyl chain having from about 6 to about 22 carbon atoms. The cationic polysaccharide polymer and the anionic surfactant undergo associative phase separation such that when the fabric enhancer composition is diluted with water at a ratio of water:fabric enhancer composition of 500:1, minimum transmittance is achieved within about 10 minutes.

### CROSS REFERENCE TO RELATED APPLICATION

This application claims the benefit of U.S. Provisional Application No. 60/633661, filed on Dec. 6, 2004 and U.S. Provisional Application No. 60/727,682, filed on Oct. 18, 2005.

### FIELD OF THE INVENTION

The present invention relates to conditioning and softener compositions. More specifically, the present invention relates to fabric softening, conditioning and enhancing compositions.

### BACKGROUND OF THE INVENTION

Current fabric conditioners can provide a multitude of benefits to clothes and fabrics treated therewith, for example, increased softness, increased fluffiness, improved perfume and/or odor impact, anti-wrinkle benefits, improved dye fidelity, anti-abrasion benefits, shape-retention benefits, static control, etc., by treating the fabric with multiple ingredients. Such ingredients are typically delivered to the fabric and deposit onto, penetrate into, and/or coat the fabric during the rinse cycle of a laundering operation. It is known to formulate fabric conditioner products with perfumes, polymers, silicone-based active agents, and/or cationic-based active agents depending upon the desired result and method of use. However, such traditional formulations have been complex and typically provide a single or limited benefit for each formula ingredient. Furthermore, these traditional formulations often require complex manufacturing, may be opaque because they are structured liquids, possess storage/physical stability problems, and/or sometimes require deposition aids. This in turn keeps the overall formulation costs high.

Accordingly, the need exists for an improved technology for providing fabric conditioning benefits in a rinse-cycle.

### SUMMARY OF THE INVENTION

The present invention relates to a rinse-added fabric enhancer composition having from about 0.01% to about 10% of a cationic polysaccharide polymer, from about 0.1 to about 50% of an anionic surfactant, and the balance adjunct ingredients. The cationic polysaccharide polymer has a weight average molecular weight of from about 400 g/mol to about 2,000,000 g/mol and a calculated charge density of from about 1% to about 50%, while the anionic surfactant has an alkyl chain having from about 6 to about 22 carbon atoms. The cationic polysaccharide polymer and the anionic surfactant undergo associative phase separation such that when the fabric enhancer composition is diluted with water at a ratio of water:fabric enhancer composition of 500:1, minimum transmittance is achieved within about 10 minutes.

It has now been found that a rinse-added fabric enhancing product based upon associative phase separation can provide multiple benefits with fewer ingredients, and even provide a different fabric softness feel. In addition, the invention herein may more efficiently deposit onto fabrics and therefore reduce overall formulation costs. In addition, it has also been found that such a fabric enhancer may provide improved aesthetics flexibility, provide manufacturing simplicity, maintain the fabric's inherent water absorbency, and/or provide a silk-like fabric softness feeling to the touch.

### DETAILED DESCRIPTION OF THE INVENTION

All temperatures herein are in degrees Celsius (° C.) unless otherwise indicated. Unless otherwise noted, all percentages herein are measured by weight and as a percentage of the final fabric enhancer composition. As used herein, the term “comprising” means that other steps, ingredients, elements, etc. which do not adversely affect the end result can be added. This term encompasses the terms “consisting of” and “consisting essentially of”.

As used herein, “charge density” means the degree of substitution or protonation of cationic charge and can be calculated by the cationic charge per 100 sugar repeating units. One cationic charge per 100 sugar repeating units equals to a 1% charge density. Charge density is measured at the in-use pH.

The present invention relates to a rinse-added fabric enhancer composition having from about 0.01% to about 10% of a cationic polysaccharide polymer, from about 0.1 to about 50% of an anionic surfactant, and the balance adjunct ingredients. The cationic polysaccharide polymer has a weight average molecular weight of from about 400 g/mol to about 2,000,000 g/mol and a calculated charge density of from about 1% to about 50%, while the anionic surfactant has an alkyl chain having from about 6 to about 22 carbon atoms. The cationic polysaccharide polymer and the anionic surfactant undergo associative phase separation such that when the fabric enhancer composition is diluted with water at a ratio of water:fabric enhancer composition of 500:1, minimum transmittance is achieved within about 10 minutes.

Cationic Polysaccharide Polymer

Generally, the cationic polysaccharide polymer is present at a level of from about 0.01% to about 10%, or from 0.05% to about 8%, or from about 0.06% to about 4% by weight of the final composition. The cationic polysaccharide polymer has a calculated charge density of from about 1% to about 50%, or 1% to about 25%, or from about 2% to about 22%. The cationic polysaccharide polymer herein is typically a cellulose derivative having the general structure: 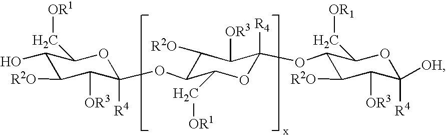
where x is from about 1 to about 15,000, or as needed to meet the molecular weight described herein, and R¹, R², R³ can independently be: H, —CH₃, or C₂₋₂₄ alkyl (linear or branched) or 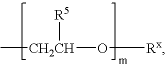
where m is about 1 to about 10. In an embodiment herein, m is from about 1 to about 5. R⁵ is independently selected from H, —CH₃, or —CH₂CH₃. In an embodiment herein, R⁵ is H or —CH₃. R^{x} is H, —CH₃, C₂₋₂₄ alkyl (linear or branched) or 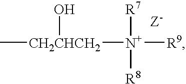
where R⁷, R⁸, and R⁹ are each independently —CH₃, —CH₂CH₃, or phenyl. In an embodiment herein, R⁷, R⁸, and R⁹ are each —CH₃. Z⁻ is typically a charge-balancing anion such as a halogen, methylsulfate, lactate, and/or citrate. In an embodiment herein, Z⁻ is selected from I⁻, Cl⁻ or Br⁻.

In the above formulas, R⁴ is H, or 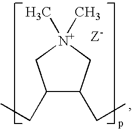
where each p is=1 or 2.

In an embodiment herein, R⁴ is H. In another embodiment herein, R⁴ is:

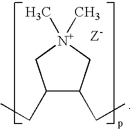

The cationic polysaccharide polymer useful herein has a weight average molecular weight of from about 400 g/mol to about 2,000,000 g/mol. In an embodiment herein, the cationic polysaccharide polymer has a weight average molecular weight of from about 400 g/mol to about 1,000,000 g/mol. In another embodiment herein, the cationic polysaccharide polymer has a weight average molecular weight of from about 200,000 g/mol to about 800,000 g/mol.

The cationic polysaccharide polymer useful herein also has an average calculated charge density of from about 0.01% to about 70%. In an embodiment herein, the cationic polysaccharide polymer has an average calculated charge density of from about 0.01% to about 50%. In an embodiment herein, the cationic polysaccharide polymer has an average calculated charge density of from about 10% to about 25%.

In an embodiment herein, the cationic cellulose may be hydrophobically-modified such that R¹, R² or R³ may each independently be C₈₋₂₄ alkyl.

In an embodiment herein, the cationic polysaccharide polymer is a cationic hydroxyethyl cellulose where R¹, R², R³ are each independently H or 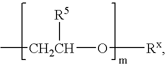
where R⁵ is H. In such an embodiment, m is about 2, and R^{x} is H, or 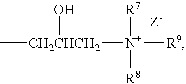
where R⁷, R⁸, and R⁹ are each —CH₃.

Examples of the cationic polysaccharide polymer useful herein include Polyquaternium 10, JR125, LR400, and JR400 all available from Dow Chemical Company, Midland, Mich., USA.

In another embodiment herein, the cationic polysaccharide polymer is chitosan or a derivative thereof such as a modified chitosan. The chitosan useful herein may be the salt of an organic or a mineral acid, and preferably has the structure: 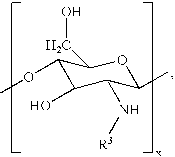
where x is from about 4 to about 15,000, or as needed to meet the molecular weight described herein, and R¹ and R²═H, and each R³ is independently H or 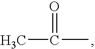
and a degree of acetylation of from about 0% to about 75%. In an embodiment herein, the degree of acetylation is from about 0% to about 50%. The degree of acetylation herein is measured as the percentage of the total number R³ and R⁴ moieties which have the formula:

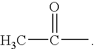

The chitosan herein has an average molecular weight from about 360 g/mol to about 2,000,000 g/mol. In an embodiment herein, the chitosan has an average molecular weight of from about 360 g/mol to about 100,000 g/mol.

The modified chitosan useful herein has a structure of: 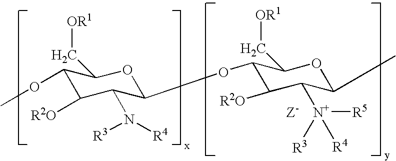
where x+y=from about 4 to about 12,000, and typically as a ratio of x:y of from about 1000:1 to about 4:3. In an embodiment herein, the modified chitosan useful herein has as a ratio of x:y of from about 100:1 to about 2:1.

In the modified chitosan useful herein, R¹, R² are each independently H, —CH₃, or C₂₋₂₄ alkyl (linear or branched), or R¹, R² are each independently H, —CH₃, or C₈₋₂₄ alkyl (linear or branched). R³, R⁴, R⁵, are each independently —CH₃, C₂₋₂₄ alkyl (linear or branched), or

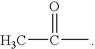

In another embodiment, R³, R⁴, R⁵, are each independently —CH₃, C8-24 alkyl (linear or branched), or

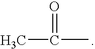

In the above formula for modified chitosan, Z⁻ is present to balance out the ionic charge and is typically selected from halogen, methylsulfate, citrate, lactate, or a mixture thereof, or Cl⁻, Br⁻, I⁻, citrate, lactate, or mixtures thereof. The modified chitosan herein has an average molecular weight from about 360 g/mol to about 2,000,000 g/mol. In an embodiment herein, the modified chitosan has an average molecular weight of from about 1000 g/mol to about 200,000 g/mol.

In another embodiment herein, the chitosan derivative is oligochitosan or its salts with average molecular weight of 360 g/mol to 10,000 g/mol. Such an oligochitosan may also have a degree of acetylation of from about 0 to about 25%.

In another embodiment herein, the chitosan derivative is a quaternized chitosan where R³, R⁴, and R⁵ are —CH₃, each Z⁻ is independently selected from lactate, I⁻, Cl⁻ or Br⁻ and where the ratio of x:y is from about 100:1 to about 4:1. In a quaternized chitosan herein, the average molecular weight is from about 360 g/mol to about 50,000 g/mol.

In another embodiment herein, the chitosan derivative is a hydrophobically-modified quaternized chitosan where R³ and R⁴ are —CH₃ and R⁵ is a C₁₂₋₁₈ (linear or branched, saturated or unsaturated) alkyl; each Z⁻ is independently selected from lactate, I⁻, Cl⁻ or Br⁻, and the ratio of x:y is from about 100:1 to about 4:1. The average molecular weight is from about 360 g/mol to about 50,000 g/mol. The degree of hydrophobic modification, defined as the number of alkyl units per 100 monomeric units, is from about 0.1 to about 10.

In one aspect of the invention, cationic starch refers to starch that has been chemically modified to provide the starch with a net positive charge in aqueous solution at pH 3. This chemical modification includes, but is not limited to, the addition of amino and/or ammonium group(s) into the starch molecules. Non-limiting examples of these ammonium groups may include substituents such as trimethylhydroxypropyl ammonium chloride, dimethylstearylhydroxypropyl ammonium chloride, or dimethyldodecylhydroxypropyl ammonium chloride. See Solarek, D. B., Cationic Starches in Modified Starches: Properties and Uses, Wurzburg, O. B., Ed., CRC Press, Inc., Boca Raton, Fla. 1986, pp 113-125.

The source of starch before chemical modification can be chosen from a variety of sources including tubers, legumes, cereal, and grains. Non-limiting examples of this source starch may include corn starch, wheat starch, rice starch, waxy corn starch, oat starch, cassava starch, waxy barley, waxy rice starch, glutinous rice starch, sweet rice starch, amioca, potato starch, tapioca starch, oat starch, sago starch, sweet rice, or mixtures thereof.

In one embodiment of the invention, cationic starch for use in the present compositions is chosen from cationic maize starch, cationic tapioca, cationic potato starch, or mixtures thereof. In another embodiment, cationic starch is cationic maize starch.

The cationic starch in the present invention may compromise one or more additional modifications. For example, these modifications may include cross-linking, stabilization reactions, phophorylations, hydrolyzations, cross-linking. Stabilization reactions may include alkylation and esterification.

Cationic starch of the present invention may comprise a maltodextrin. In one embodiment, cationic starch of the present invention may comprise a Dextrose Equivalence (“DE”) value of from about 0 to about 35. The Dextrose Equivalence value is a measure of the reducing equivalence of the hydrolyzed starch referenced to dextrose and expressed as a percent (on dry basis). One skilled in the art will readily appreciate that a completely hydrolyzed starch to dextrose has a DE value of 100, while unhydrolyzed starch has a DE of 0. In one embodiment of the invention, the cationic starch of the present invention comprises maltodextrin and comprises a DE value of from about 0 to about 35, preferably of from about 5 to about 35. A suitable assay for DE value includes one described in “Dextrose Equivalent,” Standard Analytical Methods of the Member Companies of the Corn Industries Research Foundation. 1Ed., Method E-26. Cationic starch of the present invention may comprise a dextrin. One skilled in the art will readily appreciate that dextrin is typically a pyrolysis product of starch with a wide range of molecular weights.

In one embodiment of the present invention, the cationic starch of the present invention may comprise a particular degree of substitution. As used herein, the “degree of substitution” of cationic starches is an average measure of the number of hydroxyl groups on each anhydroglucose unit which are derivitised by substituent groups. Since each anhydroglucose unit has three potential hydroxyl groups available for substitution, the maximum possible degree of substitution is 3. The degree of substitution is expressed as the number of moles of substituent groups per mole of anhydroglucose unit, on a molar average basis. The degree of substitution can be determined using proton nuclear magnetic resonance spectroscopy (“¹H NMR”) methods well-known in the art. Suitable ¹H NMR techniques include those described in “Observation on NMR Spectra of Starches in Dimethyl Sulfoxide, Iodine-Complexing, and Solvating in Water-Dimethyl Sulfoxide”, Qin-Ji Peng and Arthur S. Perlin, Carbohydrate Research, 160 (1987), 57-72; and “An Approach to the Structural Analysis of Oligosaccharides by NMR Spectroscopy”, J. Howard Bradbury and J. Grant Collins, Carbohydrate Research, 71, (1979), 15-25. In one embodiment of the invention, the cationic starch comprises a degree of substitution of from about 0.01 to about 2.5, preferably from about 0.01 to about 1.5, and more preferably from about 0.025 to about 0.5. In another embodiment of the invention, when the cationic starch comprises cationic maize starch, said cationic starch preferably comprises a degree of substitution of from about 0.04 to about 0.06. In still another embodiment of the invention, when the cationic starch comprises a hydrolyzed cationic starch, said cationic starch comprises a degree of substitution of from about 0.02 to about 0.06.

One skilled in the art will readily appreciate that starch, particularly native starch, comprises polymers made of glucose units. There are two distinct polymer types. One type of polymer is amylose whereas the other is amylopectin. The cationic starch of the present invention may be further characterized with respect to these types of polymers. In one embodiment, the cationic starch of the present invention comprises amylose at a level of from about 0% to about 70%, preferably from about 10% to about 60%, and more preferably from about 15% to about 50%, by weight of the cationic starch. In another embodiment, when the cationic starch comprises cationic maize starch, said cationic starch preferably comprises from about 25% to about 30% amylose, by weight of the cationic starch. The remaining polymer in the above embodiments essentially comprises amylopectin.

A suitable techniques for measuring percentage amylose by weight of the cationic include the methods described by the following: “Determination of Amylose in Cereal and Non-Cereal Starches by a Colorimetric Assay: Collaborative Study”, Christina Martinez and Jacques Prodolliet, Starch, 48 (1996), pp. 81-85; and “An Improved Colorimetric Procedure for Determining Apparent and Total Amylose in Cereal and Other Starches”, William R. Morrison and Bernard Laignelet, Journal of Cereal Science, 1 (1983).

The cationic starches of the present invention may comprise amylose and/or amylopectin (hereinafter “starch components”) at a particular molecular weight range. In one embodiment of the invention, the cationic starch comprises starch components, wherein said starch components comprise a molecular weight range of from about 50,000 to about 10,000,000; or from about 150,000 to about 7,000,000, or from about 250,000 to about 4,000,000, or from about 400,000 to about 3,000,000. In another embodiment, the molecular weight of said starch component is from about 250,000 to about 2,000,000. As used herein, the term “molecular weight of starch component” refers to the weight average molecular weight. This weight average molecular weight may be measured according to a gel permeation chromatography (“GPC”) method described in U.S. Publication No. 2003/0154883 A1 to MacKay, et al., entitled “Non-Thermoplastic Starch Fibers and Starch Composition for Making Same”, published on Aug. 21, 2003.

In one embodiment of the invention, the cationic starch of the present invention is hydrolyzed to reduce the molecular weight of such starch components. The degree of hydrolysis may be measured by Water Fluidity (WF), which is a measure of the solution viscosity of the gelatinized starch. A suitable method for determining WF is described at columns 8-9 of U.S. Pat. No. 4,499,116 to Zwiercan, et al., granted on Feb. 12, 1985. One skilled in the art will readily appreciate that cationic starch that has a relatively high degree of hydrolysis will have low solution viscosity or a high water fluidity value. One embodiment of the invention comprises, a cationic starch comprises a viscosity measured as WF having a value from about 50 to about 84, or from about 65 to about 84, or from about 70 to about 84. A suitable method of hydrolyzing starch includes one described by U.S. Pat. No. 4,499,116, at column 4. In one embodiment, the cationic starch of the present invention comprises a viscosity measured by Water Fluidity having a value of from about 50 to about 84.

The cationic starch in present invention may be incorporated into the composition in the form of intact starch granules, partially gelatinized starch, pregelatinized starch, cold water swelling starch, hydrolyzed starch (e.g., acid, enzyme, alkaline degradation), or oxidized starch (e.g., peroxide, peracid, alkaline, or any other oxidizing agent). Fully gelatinized starches may also be used, but at lower levels (e.g., from about 0.1% to about 0.8% by weight of the cationic starch) to prevent fabric stiffness and limit viscosity increases. Fully gelatinized starches may be used at the higher levels (e.g., of from about 0.5% to about 5% by weight of the cationic starch) when the molecular weight of the starch material has been reduced by hydrolysis.

Suitable cationic starches for use in the present compositions are commercially-available from Cerestar, Mechelen, Belgium, under the trade name C*BOND® and from National Starch and Chemical Company, Bridgewater, N.J., USA, under the trade name CATO® 2A.

The cationic polysaccharide polymer useful herein may also be a cationic guar gum of the formula: 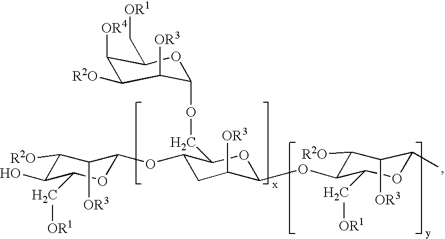
where x+y is from about 2 to about 15,000, and where each R¹, R², R³ and R⁴ is independently H or: 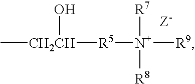
where each R⁷, R⁸, and R⁹ is independently —CH₃, —CH₂CH₃ or phenyl. Each R⁵ is independently selected from alkylene, oxalkylene, polyoxyalkelene, hydroxyalkylene or mixtures thereof. In an embodiment herein, each R⁵ is independently selected from methylene and ethylene. The cationic guar gum useful herein typically has an average molecular weight of from about 5,000 g/mol to about 5,000,000 g/mol, and a charge density of from about 0.1% to about 50%. In an embodiment herein, the cationic guar gum has an average molecular weight of from about 5,000 g/mol to about 1,500,000 g/mol, and a charge density of from about 0.1% to about 35%.

In an embodiment herein, the cationic guar gum is a hydroxypropyltrimethylammonium chloride guar gum where each R¹, R², R³ is independently: 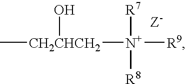
where R⁷, R^{8,} and R⁹ are each methyl and each Z⁻ is independently selected from a fabric conditioner-suitable anion, such as a halogen or methylsulfate, and especially Cl⁻, Br⁻, and I⁻. The average molecular weight of the hydroxypropyltrimethylammonium chloride guar gum is from about 50,000 g/mol to about 700,000 g/mol, and has a charge density of from about 5% to about 25%. Examples of such hydroxypropyltrimethylammonium chloride guar gums include Jaguar C13S, Jaguar Excell and Jaguar C17, available from Rhodia USA, Cranbury, N.J., USA.

In an embodiment of the invention, the cationic polysaccharide polymer includes one or more protonatable nitrogens therein and therefore obtains a portion, or all, of the net cationic charge via one or more of these protonatable nitrogens. Each protonatable nitrogen has at least one pKₐ.

Anionic Surfactant

Generally, the present invention contains from about 0.1% to about 50%, or from about 0.5% to about 45%, or from about 1% to about 40% by weight of the final composition of an anionic surfactant. The anionic surfactant has an alkyl chain length of from about 6 carbon atoms (C₆), to about 22 carbon atoms (C₂₂). Nonlimiting examples of anionic surfactants useful herein include:
a) linear alkyl benzene sulfonates (LAS), especially C₁₁-C₁₈ LAS;
   b) primary, branched-chain and random alkyl sulfates (AS), especially C₁₀-C₂₀ AS;
   c) secondary (2,3) alkyl sulfates having formulas (I) and (II), especially C₁₀-C₁₈ secondary alkyl sulfates: 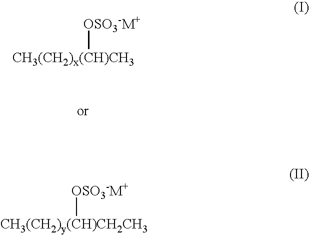
   M in formulas (I) and (II) is hydrogen or a cation which provides charge neutrality. For the purposes of the present invention, all M units, whether associated with a surfactant or adjunct ingredient, can either be a hydrogen atom or a cation depending upon the form isolated by the artisan or the relative pH of the system wherein the compound is used. Non-limiting examples of preferred cations include sodium, potassium, ammonium, and mixtures thereof. Wherein x is an integer of at least about 7, or at least about 9; and y is an integer of at least 8, or at least about 9;
   d) alkyl alkoxy sulfates (AEₓS), especially C₁₀-C₁₈ AES wherein x is preferably from about 1-30;
   e) alkyl alkoxy carboxylates, especially C₆-C₁₈ alkyl alkoxy carboxylates, preferably comprising about 1-5 ethoxy units;
   f) mid-chain branched alkyl sulfates as discussed in U.S. Pat. No. 6,020,303 to Cripe, et al., granted on Feb. 1, 2000; and U.S. Pat. No. 6,060,443 to Cripe, et al., granted on May 9, 2000;
   g) mid-chain branched alkyl alkoxy sulfates as discussed in U.S. Pat. No. 6,008,181 to Cripe, et al., granted on Dec. 28, 1999; and U.S. Pat. No. 6,020,303 to Cripe, et al., granted on Feb. 1, 2000;
   i) methyl ester sulfonate (MES);
   j) alpha-olefin sulfonate (AOS); and
   k) primary, branched chain and random alkyl or alkenyl carboxylates such as fatty alcohols, especially those having from about 6 to about 18 carbon atoms.

Fatty acids and/or soaps derived from fatty acids may also be used herein. The amount of total and free fatty acids in the product is calculated using the average molecular weight of the fatty acid and their composition determined by gas liquid chromatography (GLC). The identity, composition, molecular weight and cis/trans ratio (for unsaturated isomers) of the fatty acid extracted from the composition in question are determined separately by capillary gas liquid chromatography of the methyl ester of the fatty acids. Methyl esters are prepared directly in the product using BF₃-Methanol reagent following a modification of the AOCS Official Method Ce2-66. Then the chain length composition of the fatty acid methyl esters is analyzed by matching GLC retention times of the fatty acid methyl esters against know standards following essentially the procedures described in AOCS Official Methods Ce 1c-89 and Ce 1f-96.

The fatty acids of the present invention may be derived from (1) an animal fat, and/or a partially hydrogenated animal fat, such as beef tallow, lard, etc.; (2) a vegetable oil, and/or a partially hydrogenated vegetable oil such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, etc. ; (3) processed and/or bodied oils, such as linseed oil or tung oil via thermal, pressure, alkali-isomerization and catalytic treatments; (4) a mixture thereof, to yield saturated (e.g. stearic acid), unsaturated (e.g oleic acid), polyunsaturated (linoleic acid), branched (e.g. isostearic acid) or cyclic (e.g. saturated or unsaturated a-disubstituted cyclopentyl or cyclohexyl derivatives of polyunsaturated acids) fatty acids. Non-limiting examples of fatty acids (FA) are listed in U.S. Pat. No. 5,759,990 at col 4, lines 45-66.

Mixtures of fatty acids from different fat sources can be used, and in some embodiments preferred. Nonlimiting examples of FA's that can be blended, to form FA's of this invention are as follows:

| Fatty Acyl Group | FA¹ | FA² | FA³ |
|---|---|---|---|
| C₁₄ | 0 | 0 | 1 |
| C₁₆ | 3 | 11 | 25 |
| C₁₈ | 3 | 4 | 20 |
| C14:1 | 0 | 0 | 0 |
| C16:1 | 1 | 1 | 0 |
| C18:1 | 79 | 27 | 45 |
| C18:2 | 13 | 50 | 6 |
| C18:3 | 1 | 7 | 0 |
| Unknowns | 0 | 0 | 3 |
| Total | 100 | 100 | 100 |
| IV | 99 | 125-138 | 56 |
| cis/trans (C18:1) | 5-6 | Not Available | 7 |
| TPU | 14 | 57 | 6 |

FA¹ is a partially hydrogenated fatty acid prepared from canola oil,
FA² is a fatty acid prepared from soybean oil, and
FA³ is a slightly hydrogenated tallow fatty acid.

It is preferred that at least a majority of the fatty acid that is present in the fabric softening composition of the present invention is unsaturated, e.g., from about 40% to 100%, preferably from about 55% to about 99%, more preferably from about 60% to about 98%, by weight of the total weight of the fatty acid present in the composition. As such, it is preferred that the total level of polyunsaturated fatty acids (TPU) of the total fatty acid of the inventive composition is preferably from about 0% to about 75% by weight of the total weight of the fatty acid present in the composition.

The cis/trans ratio for the unsaturated fatty acids may be important, with the cis/trans ratio (of the C18:1 material) being from at least about 1:1, preferably at least about 3:1, more preferably from about 4:1, and even more preferably from about 9:1 or higher.

The unsaturated fatty acids preferably have at least about 3%, e.g., from about 3% to about 30% by weight, of total weight of polyunsaturates.

Typically, one would not want polyunsaturated groups in actives since these groups tend to be much more unstable than even monounsaturated groups. The presence of these highly unsaturated materials makes it desirable, and for the preferred higher levels of polyunsaturation, highly desirable, that the fatty acids of the present invention herein contain antibacterial agents, antioxidants, chelants, and/or reducing materials to protect from degradation. While polyunsaturation involving two double bonds (e.g., linoleic acid) is favored, polyunsaturation of three double bonds (linolenic acid) is not. It is preferred that the C18:3 level in the fatty acid be less than about 3%, more preferably less than about 1%, and even more preferably less than about 0.1%, by weight of the total weight of the fatty acid present in the composition of the present invention. In one embodiment, the fatty acid present in the composition is essentially free, preferably free of a C18:3 level.

Branched fatty acids such as isostearic acid are preferred since they may be more stable with respect to oxidation and the resulting degradation of color and odor quality.

The Iodine Value or “IV” measures the degree of unsaturation in the fatty acid. In one embodiment of the invention, the fatty acid has an IV preferably from about 40 to about 140, more preferably from about 50 to about 120 and even more preferably from about 85 to about 105.

Free fatty acids or salts of fatty acids can be added to the washing or rinsing laundry bath at least at a concentration of about 150 parts per million (“ppm”), preferably at least about 230 ppm, and more preferably at least about 300 ppm, up to about 600 ppm. In one embodiment, the fatty acid does not exceed 1,000 ppm in the laundry or rinse bath.

In a preferred embodiment, the FA is an alkoxylated FA having from about 1 to about 500 alkoxy groups. In a preferred embodiment the FA is an ethoxylated and/or a propoxylated FA. In a preferred embodiment, the FA is an ethoxylated FA having from about 1 to about 500 ethoxy groups, or from about 5 to about 300 ethoxy groups, or from about 7 to about 100 ethoxy groups. Without intending to be limited by theory, it is believed that such alkoxylated FAs and especially ethoxylated FAs may significantly improve the static control on fabrics contacted by the present invention. Such benefits may especially be prevalent in the case where the fabric is dried with a clothes dryer.

Without intending to be limited by theory, it is believed that fatty acids are adept at undergoing the associative phase separation desired in the present invention.

Generally, the weight ratio of cationic polysaccharide polymer: anionic surfactant is from about 2:1 to about 1:500, or from about 1:1 to about 1:400, or from about 1:5 to about 1:200.

Other adjunct ingredients useful herein include a nonionic surfactant, an other surfactant, a viscosity modifier, an opacifier, a solvent, pH-controlling agent/pH buffer, a dye, a pigment, a colorant, and/or a perfume.

Nonionic Surfactants

Generally, the present invention contains from about 0.1% to about 25%, or from about 0.5% to about 20%, or from about 1% to about 17% by weight of the final composition of a nonionic surfactant. Non-limiting examples of nonionic surfactants include:
a) C₁₂-C₁₈ alkyl ethoxylates, such as, the NEODOL® nonionic surfactants from Shell Corp.;
b) C₆-C₁₂ alkyl phenol alkoxylates wherein the alkoxylate units are a mixture of ethyleneoxy and propyleneoxy units;
c) C₁₂-C₁₈ alcohol and C₆-C₁₂ alkyl phenol condensates with ethylene oxide/propylene oxide block polymers such as Pluronic® from BASF Aktiengesellschaft;
d) C₁₄-C₂₂ mid-chain branched alcohols (BA) as discussed in U.S. Pat. No. 6,150,322 to Singleton, et al., granted on Nov. 21, 2000;
e) C₁₄-C₂₂ mid-chain branched alkyl alkoxylates (BAEₓ) wherein x is from about 1-30, as discussed in U.S. Pat. No. 6,153,577 to Cripe, et al., granted on Nov. 28, 2000;, U.S. Pat. No. 6,020,303 to Cripe, et al., granted on Feb. 1, 2000; and U.S. Pat. No. 6,093,856 to Cripe, et al., granted on Jul. 25, 2000;
f) polyhydroxy fatty acid amides as discussed in U.S. Pat. No. 5,332,528 to Pan and Gosselink, granted on Jul. 26, 1994; PCT Publication WO 92/06162 A1 to Murch, et al., published on Apr. 16, 1992; PCT Publication WO 93/19146 A1 to Fu, et al., published on Sep. 30, 1993; PCT Publication WO 93/19038 A1 to Conner, et al., published on Sep. 30, 1993; and PCT Publication WO 94/09099 A1 to Blake, et al., published on Apr. 28, 1994;
g) ether-capped poly(oxyalkylated) alcohol surfactants as discussed in U.S. Pat. No. 6,482,994 to Scheper and Sivik, granted on Nov. 19, 2002; and PCT Publication WO 01/42408 A2 to Sivik, et al., published on Jun. 14, 2001.

An opacifier may also be included herein, typically at a level of from about 0.01% to about 1%. Such an opacifier typically provides the final composition with a desirable level of cloudiness which some users expect from a fabric conditioner. However, it is recognized that such an opacifier is not needed in all cases, especially where a translucent or transparent composition is desired. Typical opacifiers useful herein include water-based styrene-acrylic emulsions, for example, the Acusol® opacifiers from Rohm & Haas, Philadelphia, Pa., USA.

A suitable solvent is water-soluble or water-insoluble and can include ethanol, propanol, isopropanol, n-butanol, t-butanol, propylene glycol, ethylene glycol, dipropylene glycol, propylene carbonate, butyl carbitol, phenylethyl alcohol, 2-methyl 1,3-propanediol, hexylene glycol, glycerol, polyethylene glycol, 1,2-hexanediol, 1,2-pentanediol, 1,2-butanediol, 1,4-cyclohexanediol, pinacol, 1,5-hexanediol, 1,6-hexanediol, 2,4-dimethyl-2,4-pentanediol, 2,2,4-trimethyl-1,3-pentanediol, 2-ethyl-1,3-hexanediol, phenoxyethanol, or mixtures thereof. Solvents are typically incorporated in the present compositions at a level of less than about 40%, preferably from about 0.5% to about 25%, more preferably from about 1% to about 10%, by weight of the final composition. Preferred solvents, especially for clear compositions herein, have a ClogP of from about −2.0 to about 2.6, preferably from about −1.7 to about 1.6, and more preferably from about −1.0 to about 1.0, which are described in detail in PCT Publication WO 99/27050 A1 (U.S. application Ser. No. 09/554,969, filed Nov. 24, 1998) by Frankenbach, et al., published on Jun. 3, 1999.

A highly preferred aspect of the compositions of the present invention is that they have a pH in a 0.2% solution in distilled water at 20° C. of less than about 7, preferably from about 1.5 to about 6.5, more preferably from about 2 to about 6. The use of this acid pH range is desirable for the compositions as it enables the rejuvenation of the smoothness of the fabric as well as a stain removal performance, in particular for bleach sensitive stains.

The pH of the compositions may be adjusted by the use of various pH controlling agents. Preferred acidifying agents include inorganic and organic acids including, for example, carboxylate acids, such as citric and succinic acids, polycarboxylate acids, such as polyacrylic acid, and also acetic acid, boric acid, malonic acid, adipic acid, fumaric acid, lactic acid, glycolic acid, tartaric acid, tartronic acid, maleic acid, their derivatives and any mixtures of the foregoing. A highly preferred pH controlling agent is citric acid, which has the advantage of providing a rejuvenation of the natural smoothness of the fabric. The pH controlling agent should be present in an amount effective to provide the above described pH level. Typical levels are from about 0.1% to about 10%, preferably from about 0.5% to about 8.5%, and more preferably about 1% to about 8%.

A pH buffer is an optional but preferred pH controlling agent for maintaining the pH of the composition. Suitable pH buffers for use herein are selected from the group consisting of alkali metal salts of carbonates, preferably sodium bicarbonate, polycarbonates, sesquicarbonates, silicates, polysilicates, borates, metaborates, phosphates, preferably sodium phosphate such as sodium hydrogenophosphate, polyphosphate like sodium tripolyphosphate, aluminates, and mixtures thereof, and preferably are selected from alkali metal salts of carbonates, phosphates, and mixtures thereof. Optimum buffering systems are characterized by good solubility, even in very hard water conditions (e.g. 30 gpg=205 mg Ca²⁺/L). In an embodiment of the invention, the pH controlling agent maintains the pH of the fabric enhancer composition at a pH which is ≦pKₐ+1, wherein the pKₐ described is the pKₐ of the protonatable cationic polysaccharide polymer, and especially the pKₐ of the protonatable nitrogens therein.

The present compositions typically include a dye, a pigment and/or a colorant to provide desirable aesthetics. Such compounds are well-known and common in the art of fabric treatment products and fabric conditioners. The present compositions preferably further comprise a perfume typically incorporated at a level of at least about 0.001%, preferably at least about 0.01%, more preferably at least about 0.1%, and up to about 10%, preferably to about 5%, more preferably to about 3%.

Product Form

In an embodiment herein, the rinse-added fabric enhancer is an isotropic composition, such as a single-phase isotropic system. In other cases, the final composition may be a suspension or a solution, as desired.

Method of Use

The present invention is typically used in a diluted form in a laundry operation, and more specifically in the rinse cycle of a laundry operation. “In diluted form”, it is meant herein that the compositions for the treating of fabrics according to the present invention may be diluted by the user, preferably with water. Such dilution may occur for instance in hand washing applications as well as by other means such as in a washing machine. Said compositions can be diluted from about 1 to about 10,000 times, from about 1 to about 5,000 times, or from about 10 to about 600 times. Typical rinse dilutions are of from about 500 to about 550 times (e.g. 20 mL in 10 L) for use in hand rinsing, and of about 375-425 times for use in a automated and non-automated washing machine (e.g., 90 mL in 35 L). This will typically, but not always occur late in the rinse cycle or during the last rinse cycle where multiple rinse cycles are used.

Method of Production

The compositions of the present invention can be manufactured by mixing together the various components of the compositions described herein in a liquid mixer as known in the art. A preferred process for manufacturing the present compositions comprises the steps of: mixing an anionic surfactant and a cationic polysaccharide polymer to form a premix and combining said premix with additional ingredients, preferably in a water seat, to form a fabric enhancing composition. Another preferred process for manufacturing the present compositions comprises the steps of: mixing an anionic surfactant and a cationic polysaccharide polymer in water, then mixing with additional ingredients to form a fabric enhancing composition.

Testing Protocols

Solution samples containing 2.5% cationic polysaccharide polymer by weight and an amount of anionic surfactant that corresponds to an anionic surfactant to cationic polymer weight ratio of 1:2, 1:1, 3:2, 2:1, 5:2, 3:1, 7:2, 4:1, 5:1, and 6:1 are prepared in deionized water. To a 1 liter beaker equipped with a magnetic stir bar and equilibrated at 25° C. in a water bath is added 10 g of one of the above solution samples and stirred. The transmittance of the resulting solution/suspension is then measured after 2 min. stirring using a DL77 Mettler Toledo Autotitrator, Mettler-Toledo, Inc., Columbus, Ohio, USA, equipped with a DP550 Phototrode also available from Mettler Toledo, which measures at a wavelength of around 555 nm. This is repeated for each solution sample. The % transmittance vs. weight ratio was then plotted to determine the surfactant to polymer ratio with minimum transmittance.

A 1 g sample of the material with minimum transmittance from the above measurement is added to a 1 liter beaker containing 500 g deionized water and equilibrated to 25° C. in a water bath. The transmittance of the resulting solution/suspension is recorded at 2 minute intervals using a program in the DL77 Mettler Toledo Autotitrator equipped with a DP550 Phototrode for 2 hours. The transmittance was then plotted vs. time, and should achieve a minimum transmittance within about 10 minutes. In an embodiment herein, the minimum transmittance is achieved in from about 0 minutes to about 10 minutes, or achieved in from about 0.25 minutes to about 8 minutes. In cases where the transmittance is to be measured in increments of less than 2 minutes, the measuring interval of the phototrode should be changed, accordingly.

Examples of the invention are set forth hereinafter by way of illustration and are not intended to be in any way limiting of the invention. The examples are not to be construed as limitations of the present invention since many variations thereof are possible without departing from its spirit and scope.

### EXAMPLE 1

Fabric enhancer compositions: % by weight

| Ingredients | (A) | (B) | (C) | (D) | (E) |
|---|---|---|---|---|---|
| Cationic Cellulose¹ | 2.5 | 2.5 | | | |
| Cationic Starch² | | | 3.0 | | |
| Cationic Guar³ | | | | 4.0 | |
| Chitosan⁴ | | | | | 4.0 |
| AS | | 5.0 | 9.0 | 12.0 | |
| AES | | | | | 12.0 |
| NI | | 1.25 | | | |
| FA | 7.5 | | | | |
| Citric Acid | | | 1.0 | | 1.0 |
| Ethanol | | 1.0 | | | |
| Propanediol | 5.0 | 3.0 | 3.0 | 3.0 | |
| Opacifier⁵ | | | 0.02 | | 0.01 |
| Acid Blue 80 | | 0.001 | | | 0.001 |
| Acid Blue 3 | 0.001 | | | | |
| Perfume | 0.9 | 0.6 | 0.9 | 1.2 | 1.2 |
| Minors | balance | balance | balance | balance | balance |

¹Cationic Hydroxyethyl Cellulose, LR400 (Dow Chemicals)
²CATO ® 232, Cationic Corn Starch (National Starch)
³Jaguar C14S (cationic guar gum from Rhodia)
⁴Oligochitosan (from Primex Ingredients ASA of Norway) MW = 5500
⁵e.g., the Acusol ® opacifiers available from Rohm & Hass

### EXAMPLE 2

Fabric enhancer compositions: % by weight

| Ingredients | (F) | (G) | (H) | (I) |
|---|---|---|---|---|
| Cationic Cellulose¹ | 3.0 | 2.5 | 1.57 | |
| Cationic Starch | | | | 2.5 |
| AS | 18.0 | | | |
| AES | | 7.5 | | |
| FA | | 5.0 | 9.43 | 10.0 |
| Ethanol | | 2.0 | 10.0 | 2.0 |
| Propanediol | | 3.0 | | |
| Opacifier² | 0.03 | | | |
| Acid Blue 80 | | 0.001 | 0.0007 | |
| Acid Blue 3 | 0.001 | | | 0.0007 |
| Perfume | 0.6 | 0.9 | 0.25 | 0.64 |
| Minors | balance | balance | balance | balance |

¹Cationic Hydroxyethyl Cellulose, LR400 (Dow Chemicals)
²e.g., the Acusol ® opacifiers available from Rohm & Hass

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A rinse-added fabric enhancer composition comprising by weight:
A. from about 0.01% to about 10% of a cationic polysaccharide polymer having a weight average molecular weight of from about 400 g/mol to about 2,000,000 g/mol and a calculated charge density of from about 1% to about 50%;
B. from about 0.1% to about 50% of an anionic surfactant comprising an alkyl chain having from about 6 to about 22 carbon atoms; and
C. the balance adjunct ingredients,
wherein the cationic polysaccharide polymer and the anionic surfactant undergo associative phase separation such that when the fabric enhancer composition is diluted with water at a ratio of water:fabric enhancer composition of 500:1, minimum transmittance is achieved within about 10 minutes.

2. The fabric enhancer composition of claim 1, wherein the weight ratio of cationic polysaccharide polymer: anionic surfactant is from about 2:1 to about 1:500.

3. The fabric enhancer composition of claim 1, further comprising from about 0.1% to about 25% of a nonionic surfactant.

4. The fabric enhancer composition of claim 1, wherein the cationic polysaccharide polymer obtains a portion or all of the net cationic charge via one or more protonatable nitrogens, wherein each protonatable nitrogen has a pKₐ and wherein the adjunct ingredient comprises from about 0.1% to about 10% of a pH controlling agent which maintains the pH of the fabric enhancer composition at a pH which is ≦pKₐ+1.

5. The fabric enhancer composition of claim 1, wherein the cationic polysaccharide polymer has a calculated charge density of from about 1% to about 25%.

6. The fabric enhancer composition of claim 1 wherein the fabric enhancer composition is an isotropic composition.

7. The fabric enhancer composition of claim 1, further comprising from about 0.01% to about 1% of an opacifier.
